(19) United States
(12) Patent Application Publication
(10) Pub. No.: US 2009/0217036 A1
(43) Pub. Date: Aug. 27, 2009

(54) DIGITAL RIGHTS MANAGEMENT

(75) Inventors: James Irwin, Reading (GB); Timothy James Wright, Reading (GB)

Correspondence Address: Workman Nydegger;1000 Eagle Gate Tower, 60 East South Temple, Salt Lake City, UT, 84111, US

(73) Assignee: VODAFONE GROUP PLC, NEWBURY, BERKSHIRE (GB)

(21) Appl. No.: 11/913,665

(22) PCT Filed: May 4, 2006
(86) PCT No.: PCT/GB2006/001616

§ 371 Date: Aug. 1, 2008

(30) Foreign Application Priority Data
May 4, 2005 (GB) 0509137.6
May 4, 2005 (GB) 0509140.0
May 20, 2005 (GB) 0510372.6

(51) Int. Cl. H04L 9/32; G06F 21/00

(52) U.S. Cl. 713/168; 726/26

(57) ABSTRACT

In a digital rights management (DRM) scheme a mobile terminal (1) registered with mobile telecommunications network (3) obtains encrypted content data (26) from content provider (21) and a rights object (28) containing a license to use that data from rights issuer (23). The mobile terminal (1) is associated with mobile terminal (11), PC (25) and PDA (27) in a domain. Various arrangements are disclosed for enabling a second device to consume the content data (26) received by the device (1). The content data (26) is consumed on the second device in a controlled manner. The second device may or may not be a member of the domain (24). The first device may enable the second device to temporarily join the domain (24), if the second device is not a member of the domain (24), in order to allow the second device to consume the content. In another embodiment the first and second devices may already be a member of the same domain (24). In this other embodiment the first and second devices are prevented from simultaneously consuming the same content. In a further embodiment, the first and second devices are not members of the same domain. In this further embodiment, the first device obtains permission from the rights issuer (23) to enable the second device to consume the content.

### TECHNICAL FIELD

The present invention relates to the controlled distribution of data between a plurality of devices.

### BACKGROUND TO THE INVENTION

Digital Rights Management (DRM) is a technology allowing encrypted digital files (or “content”) to be readily distributed to potential users without charge. The encrypted data may be freely onwardly transmitted by the user receiving the data. However, for any user to be able to make use of the data, it must be decrypted. To obtain a key to decrypt the data, a license must be purchased or otherwise obtained from a rights issuer or license broker.

DRM architecture includes the following functional entities.

Content provider: the content provider is an entity that delivers DRM content such as a song, computer program or mobile telephone ring tone. The content is typically encrypted and cannot be used in the form as received.

DRM content: this is the digital file containing data desired by the user. As indicated above, this can be freely distributed. The content is in encrypted form.

DRM agent: a DRM agent embodies a trusted entity in a device such as a mobile telephone or personal computer (PC). This trusted entity is responsible for enforcing permissions and constraints associated with DRM content, controlling access to the DRM content.

Rights object: a rights object is, for example, an XML document expressing permissions and constraints associated with a piece of DRM content. Rights objects govern how the DRM content may be used. DRM content cannot be used without an associated rights object, and may be only used as specified by the rights object. The rights object typically includes a key to allow decryption of the relevant encrypted content.

Rights issuer: the rights issuer is an entity that assigns permissions and constraints to the DRM content, and generates rights objects.

User: a user is the human user of DRM content. Users can only access DRM content through a DRM agent present on their device.

In a recent development of DRM, there have been proposals to allow a number of devices to be associated in a domain. The Open Mobile Alliance (OMA) DRM Specification V2.0 is available from the Open Mobile Alliance at the address http://www.openmobilealliance.org/release_program/drm_v20.html. The domain concept specified in the OMA DRM Specification V2.0 allows a user to register a number of their personal devices in a group or domain. Once a group of devices or domain has been established the user is free to copy content and rights between devices without the need to acquire new rights from a rights issuer. One drawback of this approach is that rights may be freely duplicated—i.e. it allows the same piece of content to be rendered on multiple devices at the same time.

### BRIEF SUMMARY OF THE INVENTION

According to a first aspect of the present invention, there is provided a method of controlling use of content data, the method including receiving encrypted content data at a first device from a content provider; receiving decryption data at the first device from a rights issuer for allowing decryption of the encrypted content data so that the content data can be consumed; and enabling a second device to consume the content data received by the first device, the content data being consumed by the first and second devices in a controlled manner.

According to a second aspect of the invention, there is provided a system for controlling use of content data, the system including means for sending encrypted content data to a first device from a content provider; means for sending decryption data to the first device from a rights issuer for allowing decryption of the encrypted content data so that the content data can be consumed; and means for enabling a second device to consume the content data received by the first device, the content data being consumed by the first and second devices in a controlled manner.

The first and second device may or may not be a member of a domain. The first and second devices may be members of different domains, or members of the same domain. Devices that are members of the same domain can share decryption data received from the rights issuer so that the associated content can be consumed by member devices sharing this decryption data. In the embodiments, each of the devices in a domain share a domain key. The shared decryption data is encrypted using this shared domain key. Therefore, the devices in the domain are able to decrypt the share decryption data using the domain key so that the shared decryption data can be used to decrypt the associated content. Devices not in the domain are (conventionally) unable to make use of the encrypted decryption data because they do not have the shared domain key.

In a first embodiment of the invention to be described in more detail, the first device obtains permission from the rights issuer to enable the second device to consume the content. In this first embodiment typically (although not essentially) the second device is not a member of the same domain as the first device. In order to obtain this permission, the first device may obtain an authentication token from the rights issuer and provide this authentication to the second device. The authentication token may be obtained prior to the decryption data received by the first device being transmitted to the second device. The authentication token enables the second device to consume the content (and possibly other content).

In a second embodiment to be described in more detail below, the first device is operable to enable the second device to become a member of the domain so that the second device can consume the content data received by the first device. In this embodiment the first device enables the second device to become a member of the domain only temporarily. Advantageously, the first device may determine the duration of the temporary membership of the domain.

In a third embodiment to be described in more detail the first and second devices may be members of the same domain. The first device is operable to transmit the received decryption data to the second device to enable the second device to consume the content data. However, the first device is prevented from consuming the content data whilst the second device is enabled to consume the content data. Thus, simultaneous use of the content data by the first and second device is presented. The second device may only be enabled to consume the content data for a predetermined time period, whereafter the first device is able to consume the content again. The user of the first device may determine the duration of this predetermined time period. Special decryption data may be generated to enable the second device to consume the content data. For example, the device 1 may generate a new rights object (“Domain Move RO”) that defines how the second device can consume the decryption data that is sent to the second device. This new rights object may define the rule by which the second device can consume the content data (for example, it may include the predetermined time period during which the second device can consume the content. The new rights object may be encrypted so that only the first device and the second device can use the new rights object.

### BRIEF DESCRIPTION OF THE DRAWINGS

For a better understanding of the present invention, embodiments will now be described by way of example, with reference to the accompanying drawings, in which:

FIG. 1 shows schematically the elements of a telecommunications network in accordance with the invention;

FIG. 2 shows the data exchanges that take place between a device and a rights issuer when the device wishes to join a domain;

FIG. 3 shows the data exchanges that take place between a device and a rights issuer when a device registers with a rights issuer in order to obtain an authentication token from the rights issuer in accordance with a first embodiment of the invention;

FIG. 4 shows the data exchanges that occur to exchange a security token between a first device and a second device in accordance with a first embodiment of the invention;

FIG. 5 shows the data exchanges that take place when a device is temporarily added to a domain in accordance with a second embodiment of the invention; and

FIG. 6 shows the data exchanges that take place when it is desired to exchange content between a first device and a second device, where that content is not permitted to be copied, in accordance with a third embodiment of the invention.

In the drawings like elements are generally designated with the same reference numerals.

### DETAILED DESCRIPTION OF EMBODIMENTS

Mobile terminal 1 is registered with GSM/GPRS or UMTS (3G) mobile telecommunications network 3. The mobile terminal 1 may be a handheld telephone (as shown), a personal digital assistant (PDA) or a laptop computer equipped with a datacard. The mobile terminal communicates wirelessly with mobile telecommunications network 3 via the radio access network (RAN) of the network 3, comprising, in the case of a UMTS network, base station (Node B) 5, and radio network controller (RNC) 7. Communications between the mobile terminal 1 and the network 3 are routed from the radio access network via GPRS support nodes (S/GGSN) 9, which may be connected by a fixed (cable) link to the network 3.

In the conventional manner, a multiplicity of mobile terminals are registered with the network 3. These mobile terminals include mobile terminal 11 and mobile terminal 13. The mobile terminals 11 and 13 communicate with the network 3 in a similar manner to the terminal 1, that is via an appropriate node B 5, RNC 7 and S/GGSN 9.

Each of the mobile terminals 1,11 and 13 is provided with a respective subscriber identity module (SIM) 15. During the manufacturing process of each SIM, authentication information is stored thereon under the control of the network 3. The network 3 itself stores details of each of the SIMs issued under its control. In operation of the network 3, a terminal 1,11,13 is authenticated (for example when the user activates the terminal in the network with a view to making or receiving calls) by the network sending a challenge to the terminal 1,11,13 incorporating a SIM 15, in response to which the SIM 15 calculates a reply (dependent on the predetermined information held on the SIM—typically an authentication algorithm and a unique key Ki) and transmits it back to the network 3. The network 3 includes an authentication processor 17 which generates the challenge and which receives the reply from the terminal 1,11,13. Using information pre-stored concerning the content of the relevant SIM 15, the authentication processor calculates the expected value of the reply from the mobile terminal 1,11,13. If the reply received matches the expected calculated reply, the SIM 15 and the associated mobile terminal are considered to be authenticated.

It should be understood that such an authentication process can be performed by any terminal provided with a SIM 15 under control of the network 3. In the embodiment the terminal communicates wirelessly with the network 3 via the networks radio access network, although this is not essential. For example, the terminal may communicate with the network 3 via the fixed telephone network (PSTN) and/or via the Internet.

The SIM 15 used by the terminals 1,11,13 may be a SIM of the type defined in the GSM or UMTS standards specifications, or may be a simulation of a SIM—that is, the software or hardware that performs a function corresponding to that of a SIM—for example, as described in WO-A-2004/036513.

In the embodiments the mobile terminal 1 includes a trusted module and DRM download agent 19. This is hardware or software that is trusted to securely handle rights objects received from rights issuer 23. The rights issuer 23 is connected to the network 3 via a wireless or fixed link, for example via the Internet. Similarly, content provider 21 is coupled to the network 3 via a wireless or fixed link, for example via the Internet. The mobile terminal 1 may form a domain 24 in which the mobile terminal 1, mobile terminal 11, PC 25 and PDA 27 are associated. Some of the components of the domain (mobile terminals 1 and 11) are capable of wireless communication with the network 3, whereas some of the components (PC 25 and PDA 27) are not capable of wireless communication directly with the network 3 but are capable of local communication with the mobile terminal 1, for example via a Bluetooth® wireless link, an infra-red link or a cable link such as USB.

The domain 24 formed between the devices 1,11,25 and 27 in the embodiments is a domain in accordance with OMA DRM Specification V2.0. According to that specification the devices in a domain are defined as a number of devices that belong to or are associated with a single user (although this is not essential to the invention) and are provided with a common domain key which is obtained from the rights issuer 23. The rights issuer 23, by controlling the provision of the domain key, defines domains by managing the domain keys. The rights issuer 23 controls the addition or removal of devices from the domain. The user may request that a device is added or removed from a domain. Whether or not this request is accepted is determined by the rights issuer 23. Conversely a user can choose to remove a device from a domain and this does not require authorization from the rights issuer; however, the fact that the device has left the domain is reported back to the rights issuer as the rights issuer may only allow a specific number of devices to belong to a domain at any one point in time.

If the rights issuer allows the device to join the domain then it sends the device the keys and rights objects that are needed to access the content within that domain. Once a device is added to a domain then the user can move content and rights between that device and other devices in the domain without the need to acquire any additional rights objects. This is achieved through protecting the rights object with a shared key (the domain key) rather than the device's public key, which is the usual case. Each device in a domain is provided with a domain rights object, which is encrypted by the domain key. The content is protected by the domain rights object—which is made available to each device in the domain (rather than a rights object usable on only one device). This allows the content to be consumed by any device in the domain. The domain rights object and domain key is transported to the devices within the Domain Join variant of the ROAP (Right Object Acquisition Protocol).

When a device is removed from a domain, the domain key is deleted and the device no longer has access to the domain content. Additionally a rights issuer can forcefully remove a device from a domain by upgrading the domain generation, when this happens the domain key is changed. If the user wishes to consume new domain content on a specific device then that device must reregister since any new domain content will be encrypted with the new domain key. The rights issuer can at this point refuse to re-register a specific device and therefore exclude it from the domain and therefore it is unable to access the new domain content.

One device may be a member of a multiplicity of domains, and these domains may be managed by one or more rights issuers.

By associating devices 1,11,25 and 27 in a domain 24, this enables distribution of content (and rights) to devices 25 and 27 that are not capable of communicating directly with the content provider 21 (and rights issuer 23). The content and rights are obtained by the mobile terminal 1 via the network 3 and are then distributed to the other devices in the domain 24 by a local communication link.

In a conventional DRM arrangement (where no domains are provided), the user of the mobile terminal 1 may browse content available from content provider 21 via the radio access network of mobile telecommunications network 3 and an Internet connection between the network 3 and the content provider 21, using, for example, a WAP browser provided on the mobile terminal 1. When the user of mobile terminal 1 identifies content that they wish to obtain from the content provider 21, the mobile terminal 1 is used to send a request via the network 3 and the Internet for the content to the content provider 21. The requested content 26 is transmitted to the mobile terminal 1 via the Internet and the network 3 in encrypted form such that the content 26 is of no use to the user of the mobile terminal 1 in the form that it is received. At this stage no charge has been made to the user of the mobile terminal 1 of the content provided by the content provider 21. If desired, the mobile terminal 1 may be used to onwardly transmit the encrypted content to other users in the network 3 and beyond. However, these other users will not be able to make use of the content as it is encrypted form at this stage.

When the user of mobile terminal 1, or the user of any other terminal to which the content 26 has been transmitted, wishes to make use of this content 26, they will be prompted by their terminal to purchase “rights” to make use of the content 26. If the user of the mobile terminal 8 accepts the purchase, this is communicated in the form of, for example, an SMS or WAP call to the rights issuer 23 via the radio access network of the mobile telecommunications network 3 and, for example, the Internet. The rights issuer 23 has an agreement with the content provider 21 to provide rights objects (licenses) for use of the content 26. The payment for the rights object could be made, for example, by deducting an appropriate amount from the account of the user of the mobile terminal 1 with the network 3. When the payment has been made, a rights object 28 including a license and content decryption key in the form of an SMS message or other type of message is sent to the mobile terminal 1 by the rights issuer 23 via the Internet and the radio access network of the mobile telecommunications network 3. The rights object 28 might, for example, grant the user of the mobile terminal 3 unlimited use of the content, or may restrict use of the content for a particular time period or for a particular number of uses (for example, if the content is recorded music, the license may allow the music to be played ten times only), depending on the price paid for the content by the user. If the time period of use of the content is restricted, preferably the devices receiving the content are provided with a secure clock, such as described in GB-A-2403382.

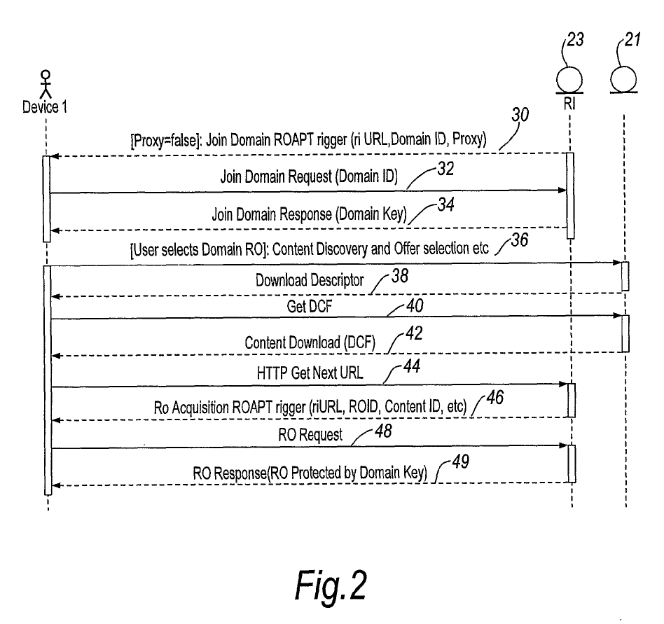

The data exchanges that occur when device 1 joins the domain 24 and obtains content for consumption will now be described briefly with reference to FIG. 2.

Initially, rights issuer 23 sends device 1 a message to invite device 1 to join the domain 24 in message 30 “(Proxy=false):JoinDomainROAPTrigger(riURL, DomainID, Proxy)”. The message 30 includes riURL, which is the URL via which the device 1 can register with the rights issuer 23. The message also includes DomainID, the identity of the domain 24. On receipt of the message 30, if the user of device 1 wishes to join the domain 24, the user operates the device 1 to respond with a join domain request message 32 “JoinDomainRequest(DomainID)”. The message 32 includes the DomainID provided in the invitation message 30. On receipt of the message 32, the rights issuer 23 responds by sending a join domain message 34 “JoinDomainResponse(DomainKey)” to device 1, which message includes the domain key. As part of this joining process the user of device 1 may select a domain rights object 28 (DomainRO) that the user wishes to obtain. The domain rights object 28 is obtained from rights issuer 23. The domain rights object 28 enables the device 1 to consume content provided within the domain 24.

The user of device 1 then operates device 1 to perform content discovery and selection—that is, the user selects content offered by the content provider 21. This selection is transmitted to the content provider 21 in message 36 “(User selects Domain RO): Content Discovery and Offer selection etc.”. The content provider 21 then replies in message 38 with a download descriptor (DD) for the selected content. The download descriptor comprises metadata about the content and instructions to the download agent 19 in the mobile terminal 1 as to how to download the selected content data. On receipt of the message 38, the device 1 requests the encrypted content (DCF) by sending an HTTP GET request i.e. message 40 “Get DCF” to the content provider 21. The content provider 21 then downloads the content DCF protected (encrypted) by the domain key by responding with the DCF i.e. a content download message 42.

As discussed above, the device 1 cannot consume the encrypted content until it has obtained a rights object for that content. Because the content is useable by all devices in the domain 24, a domain rights object is required to consume the content. This domain rights object specific for the content is required to decrypt the content in addition to the domain key. The download agent 19 on the device 1 then sends an HTTP GET to the next URL in the download descriptor (DD) in message 44 sent to the rights issuer 23. The rights issuer then responds by sending to device 1 a rights object acquisition ROAP trigger message 46 “RoAcquisitionROAPTrigger(riURL, ROID, ContentID, etc)”. The message 46 includes the riURL, the rights object ID (ROID) and the content ID. The device 1 then sends a rights object request message 48 to the rights issuer 23, requesting the rights object to decrypt the content downloaded in message 38. The rights issuer 23 then responds by sending the rights object encrypted using the domain key in message 49 “ROResponse(RO Protected by DomainKey)”.

If the mobile terminal 1 forms part of a domain 24 in accordance with the OMA DRM Specification V2.0 the rights object 28 containing the license information obtained from the rights issuer 23 by the mobile terminal 1 and the content 26 obtained from the content provider 21 may be shared with the other devices 11, 25 and 27 in the domain. That is, the rights object can be embedded in the content and so may be transmitted by the mobile terminal 1 on request to the other devices 11, 25, 27 in the domain. On receipt of the content and the associated rights object, the other devices 11, 25 and 27 may decrypt and make use of the content in a similar manner to the mobile terminal 1. The common domain key provided to each of the devices 1, 11, 25 and 27 facilitates this process.

While such an arrangement is convenient for the members of the domain 24, because the mobile terminal 1 is free to copy the content 26 and the (domain) rights object 28 to other devices in the domain 24, the content 26 and rights object 28 is in effect being duplicated so that the same piece of content 26 can be used on multiple devices. The DRM concept seeks to control the use of content by requiring a user to obtain a rights object to make use of the content. The domain concept as specified in the OMD DRM Specification V2.0 detracts from this concept by allowing the duplication of a rights object freely in a plurality of terminals in a domain albeit in a controlled manner. This will effectively bypass restrictions in the license contained in the rights object 28, such as allowing a music recording to be reproduced only ten times. The rights object 28 will still be effective for each device 1,11,25 and 27 in the domain 24 but the downloaded rights object 28 will allow the music to be reproduced ten times by each of the devices 1,11,25 and 27 (i.e. forty times in total), rather than the ten times in total as intended by the rights issuer 23.

In order to provide a user experience similar to that of physical media (such as DVDs and CDs), which is desired by content providers, DRM systems should include the ability to move content and rights between devices such that once the content has moved from one device to another device it is no longer usable in the original device. Ideally, this should be achievable without requiring a connection of either of the devices to the network 3 but whilst still maintaining a high level of security and trust that is associated with the domain concept.

The first embodiment of the invention now to be described is applicable to DRM systems in general, and not solely to DRM systems that employ the domain concept. The embodiment provides the ability to reliably determine if a device is trusted by rights issuer 23 sufficiently to itself authenticate another device for the purpose of issuing rights to that other device.

As discussed above, a device can decrypt content if it obtains the appropriate rights object 28 for that content. The key to decrypt the content is delivered with the rights object 28. Such a key is cryptographically bound to the receiving device (for example using the devices public key) in the absence of a domain, or is cryptographically bound to the domain (using the domain key), if the DRM system implements domains. The result is that only the device (or any device that belongs to the domain) can extract the content encryption key (CEK) and consume the content.

In the present embodiment the procedure when a device receives a rights object is modified so that the device is able to authenticate other devices and issue rights objects to those other devices (even if they are not in the same domain). In order to do this the device needs to establish “delegated trust” i.e. the Rights Issuer approves the device to issue Rights Objects.

In order for a device 1 to be appropriately authenticated, the device 1 registers with rights issuer 23. The registration can be based on the registration variant of ROAP used in OMA DRMV 2.0 or some other protocol whereby the device and the rights issuer 23 exchange certificates and negotiate common algorithms (if required).

Such a registration procedure is shown in FIG. 3. Device 1 initiates the registration process by sending a message “DeviceHello” 50 to the rights issuer 23. The rights issuer 23 responds with reply message “RIHello” 52. The device 1 then issues a registration request which includes the certificate of device 1 “Registration Request (CertDev1)” 54. The rights issuer 23 will then determine whether it wishes to give the device 1 the ability to authenticate other devices and issue rights objects to the other devices. This determination may be made, for example, from knowledge of the security capabilities of the device and the identity of the user. Such data may be provided as part of the registration request message 54 or may be obtained by the rights issuer 23 by some other means.

Assuming that the rights issuer 23 is willing to provide the device 1 with the ability to authenticate other devices and issue rights objects to other devices, the certificate of device 1 is signed by the rights issuer 23, which results in an authentication token which is transmitted to the device 1 in message “Registration Response (Rlpk(CertDev1)) 56. The token “Rlpk (CertDev1)” may be valid for only a predetermined period of time—for example, this can be the minimum or average time it takes to revoke a device for the trust model used.

The token can be used by the device 1 to prove that the rights issuer 23 trusts device 1 for the predetermined period of time. When this predetermined time has expired the device 1 must repeat the process shown in FIG. 3 to acquire a new token if the device 1 wishes to authenticate other devices and issue rights objects to other devices.

The token received by device 1 in the message 56 can then be exchanged with another device 13 and indicates to that other device 13 that the device 11 is trusted by the rights issuer 23. The other device 13 then responds to the device 1 with its certificate to demonstrate to device 1 that the other device 13 is trusted by the rights issuer 23. The device 13 is not a member of domain 24 in this example.

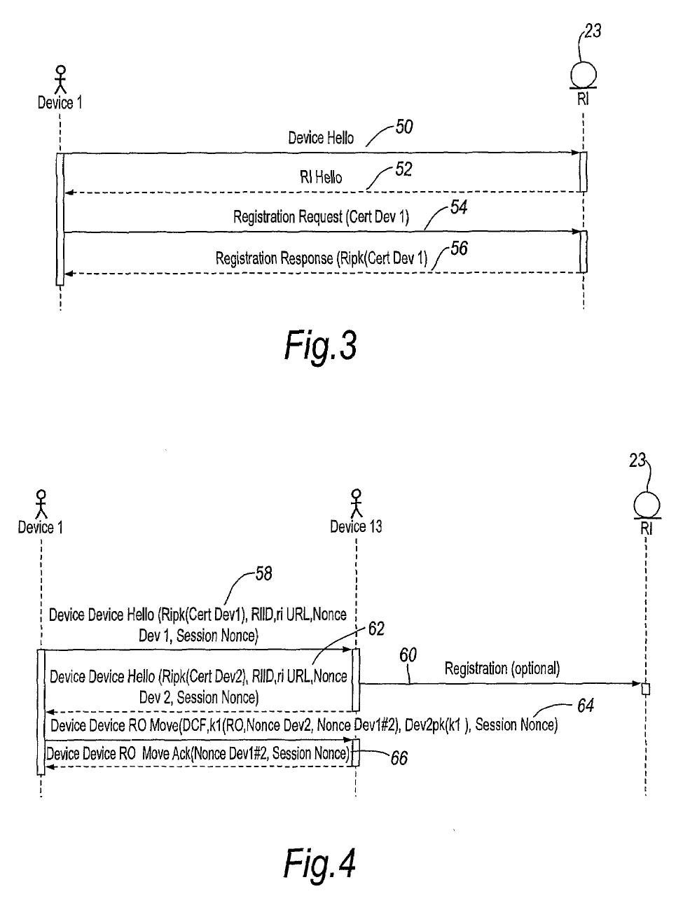

FIG. 4 shows this exchange of security token and certificate. The device 1 sends the authentication token received in message 56 in FIG. 3 to the other device 13 in message 58 “DeviceDeviceHello(Rlpk(CertDev1),RIID,riURL, NonceDev1,SessionNonce)”. The message 58 includes, in addition to the authentication token, also the rights issuer ID (RIID), the URL via which a device can register with rights issuer 23 (riURL), a nonce (random number) chosen by device 1 (NonceDev1) and a nonce chosen by the communication initiating device 1 (SessionNonce). If the device 13 does not have an authentication token from the rights issuer identified by RllD (for example, obtained by the process described in relation to FIG. 3), the device 13 may perform the registration process of the type described in relation to FIG. 3 with the rights issuer 23, as indicated at message 60. When the device 13 has registered with the rights issuer 23 (or if this is not required because the device 13 is already registered with the rights issuer 23 and has a valid/non-expired authentication token), the device 13 responds to the device 1 by sending message “DeviceDeviceHello(Rlpk(CertDev2),RIID,riURL,Nonce Dev2,SessionNonce)” 62. This message includes the certificate of the device 13 “Rlpk(CertDev2)” signed by the rights issuer 23 to provide the device 2 with an authentication token. Like the authentication token of device 1, the authentication token of device 13 may be valid for only a predetermined period of time. The message 62 includes similar elements to message 58 but of course the authentication token (Rlpk(CertDev2)) of device 13 and the Nonce is a random number chosen by device 13 (NonceDev2). The nonces NonceDev1 and SessionNonce are used to identify the communication session between the device 1 and the device 13 and prevent replay attacks.

Upon reception of the message 62 from device 13, the device 1 checks the signature on the authentication token received from device 13 and if the signature is still valid and has not expired, device 1 can respond by sending a rights object move message (“DeviceDeviceROMove(DCF,kl (RO,NonceDev2,NonceDev1#2),Dev2pk(k1),SessionNonce)” 64 to device 13. The message 64 may optionally contain the protected content (DCF), the rights object (RO) the NonceDev2 and a second nonce chosen by device 1 used for confirming the data exchange with device 13 (NonceDev1#2). The rights object, NonceDev2 and NonceDev1#2 may be encrypted with a symmetric key (K1) chosen by the initiating device 1. The key K1 is itself transmitted, which has been encrypted with the public key of device 2 (Dev2pk). Finally, the SessionNonce is also included in the message 64.

Upon reception of message 64, the device 13 decrypts K1 and then decrypts the rights object and NonceDev1#2. To acknowledge receipt of the message, device 13 responds with a rights object move acknowledgement message “DeviceDeviceROMMoveAck(NonceDev1#2,SessionNonce)” 66. Message 66 contains the decrypted Nonce Device 1#2 and the Session Nonce.

In the process described, the device 13 has been provided with a rights object that was initially obtained from the rights issuer 23 directly by a device 1. In the arrangement described in devices 1 and 13 both obtain an authentication token from the rights issuer 23. This indicates that devices 1 and 13 are both authenticated by the rights issuer 23 and have permission to send and/or receive rights objects. Therefore, rights objects cannot be freely distributed from device 1 to other devices. Instead, only devices that have obtained an authentication token (by a proper authentication process) with the rights issuer 23 are able to send/receive rights objects. Therefore, the integrity of the DRM principle is maintained.

A second embodiment will now be described. In this embodiment a device 1 is able to trigger the temporary addition of a device 13 to the domain 24 for a period of time defined by device.

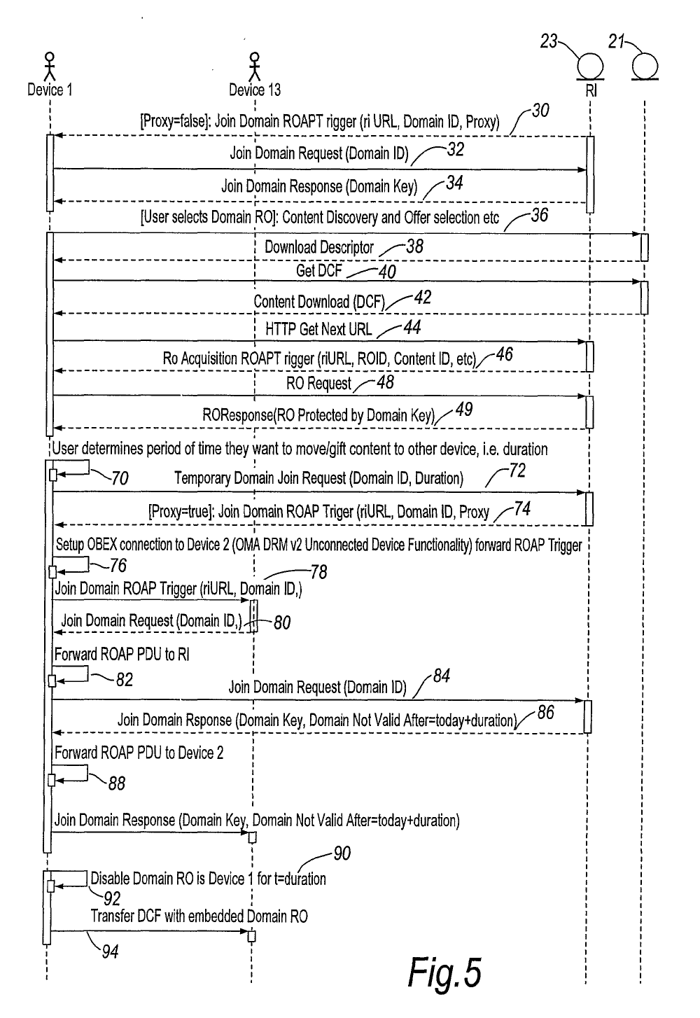

The temporary addition of the device 13 to the domain 24 will now be described with reference to the data exchanges shown in FIG. 5. If device 1 is not already a member of the domain 24, it joins the domain by exchange of messages 30,32 and 34 with rights issuer 23, as described above in relation to FIG. 2. The user of device 1 then selects and downloads encrypted content in the associated domain rights object by exchanging messages 36 to 49 with rights issuer 23 and content provider 21, as described above in relation to FIG. 2.

After reception of message 49 the device 1 is able to consume the selected content from the content provider 21 according to rules in the domain rights object contained in the message 49.

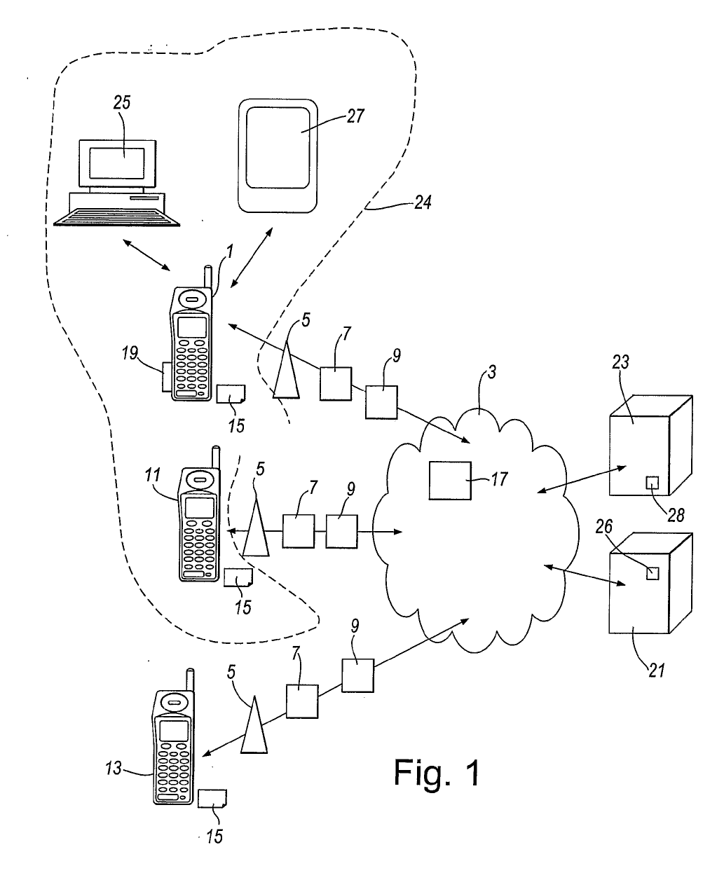

In accordance with this embodiment, the user of device 1 is able to allow a device 13 (FIG. 1) to consume the content. Device 13 is not a member of the domain 24. At step 70 (FIG. 5) the user of device 1 selects how long they wish the device 13 to be able to consume the content. Device 1 then sends a temporary domain join request message 72 “TemporaryDomainJoinRequest (DomainID, Duration)” to the rights issuer 23. The message 72 includes the domain ID and the duration for which it is desired that device 13 can consume the content. The rights issuer 23 may determine whether it wishes to allow device 13 to temporarily join the domain. If this determination is positive (or if no such determination is made), the rights issuer 23 responds with a join domain ROAP trigger message 74 “(Proxy=true):JoinDomainROAPTriger (riURL,DomainID, Proxy)” with the proxy attribute set to true (here it is assumed that device 13 is an “unconnected” device, i.e. a device that does not have the wide area connection necessary to contact the rights issuer 23 directly but does so via a connected device that acts as a proxy. The Proxy attribute in the ROAP Trigger is there to indicate to the connected device that the ROAP Trigger message should be passed on to the unconnected device 13). Message 74 includes the domain ID and the riURL. At step 76 the device 1 establishes an OBEX connection to device 13 using OMA DRM V2 Unconnected Device functionality. The device 1 then sends a ROAP trigger to device 13 in message 78 “JoinDomainROAPTrigger (riURL, DomainID)”, including the riURL and the domain ID. The device 13 responds with a join domain request message 80 “JoinDomainRequest(DomainID)”, including the domain ID. At step 82 device 1 forwards the ROAP protocol data unit (PDU) to the rights issuer 23. Device 1 then transmits a joint domain request message 84 “JoinDomainRequest(DomainID)” to the rights issuer 23, including the domain ID. This message is different from the join domain request message 32 in that it relates to the device 13, rather than the device 1). The rights issuer 23 responds with a join domain response message 86 “JoinDomainResponse(DomainKey, DomainNotValidAfter=today+duration)”. The message 86 includes a “domain not valid” parameter, in addition to the domain key. This parameter may be set so that it expires after the time specified in the temporary domain join request message 72. However, the rights issuer 23 may set the “domain not valid” parameter that it expires before the time specified in the temporary domain join request message 72, if the time specified in the message 72 is unacceptable. In this embodiment, when the Domain Context expires the Domain Keys and Domain Context are no longer valid and can not be used for any further or ongoing consumption of domain rights objects. Thus, device 13 will only be granted temporary membership of the domain 24.

At step 88 the ROAP PDU is forwarded from device 1 to device 13. The device 1 then forwards the join domain response message 86 received from the rights issuer to the device 13 in message 90. At step 92 the domain rights object is disabled on device 1 and a copy of the domain rights object is placed inside the encrypted content (DCF) that is to be transmitted to the device 13. The domain rights object in device 1 is disabled for the time specified in the temporary domain join request message 72. At step 94 the encrypted content (DCF) is forwarded to the device 13 from device 1. The device 13 can then consume the protected content in accordance with the rules in the domain rights object until the domain context expires, i.e. until the time specified in the temporary domain join request message 72. When the time specified in the temporary domain join request message 72 expires, the device 1 is again able to consume the content, this facility only being temporarily disabled in step 92.

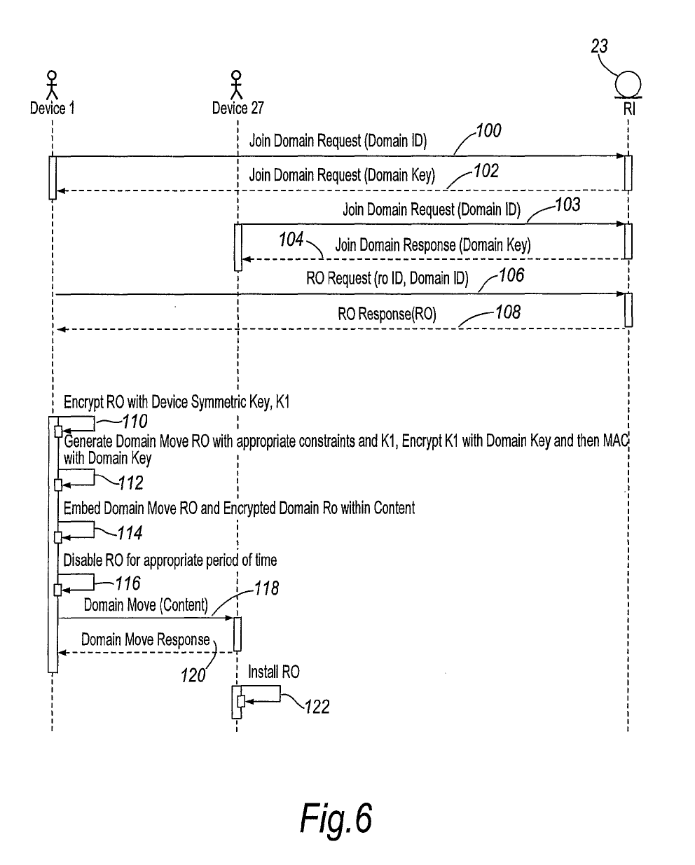

A third embodiment of the invention will now be described. The data exchanges that occur in the third embodiment will now be described in relation to FIG. 6. In this embodiment a new constraint “NoCopy” is defined which is such that a device that receives content with this constraint must not copy the domain rights object for use in other devices that belong to the domain 24. If a device wishes to give or move the domain rights object (and content), then the domain rights object must be disabled on the giving or sending device. This will now be explained in more detail.

Device 1 joins the domain and receives the domain key by exchange of messages 100,102 with the rights issuer 23. The user operates the device 1 to send a join domain request message 100 “JoinDomainRequest(DomainID)”. The message 32 includes the DomainID. On receipt of the message 32, the rights issuer 23 responds by sending a join domain message 102 “JoinDomainResponse(DomainKey)” to device 1, which message includes the domain key. Similarly, device 27 joins the domain and obtains the domain key by exchange of messages 103,104 with the rights issuer 23. The user operates the device 27 to send a join domain request message 103 “JoinDomainRequest(DomainID”). The message 103 includes the DomainID. On receipt of the message 103, the rights issuer 23 responds by sending a join domain message 104 “JoinDomainResponse(DomainKey)” to device 27 which message includes the domain key. Device 1 then obtains the (domain) rights object that enables the consumption of particular content by exchange of messages 106,108 with the rights issuer 23. The device 1 sends a rights object request message 106 to the rights issuer 23, requesting the rights object to decrypt the content. The rights issuer 23 then responds by sending the rights object encrypted using the domain key in message 108 “ROResponse (RO)”. The domain rights object in message 108 contains the constraint, CopyAllowed=False (or “NoCopy”), the semantics of which are such that the (domain) rights object cannot be copied within the domain.

If the user of device 1 wishes to move content to another device in the domain (device 27), the domain rights object is encrypted with a symmetric key K1 generated by the device 1 at step 110. The device 1 then generates a new rights object (referred to here as the Domain Move RO) that defines how other devices can consume the domain rights object. For example, if the user of device 1 wishes to allow the content to be used by the device 27 for a period of three days, then the Domain Move RO defines this rule. The Domain Move RO includes these constraints and additionally K1. K1 is encrypted with the domain key and a key derived from the domain key is used to generate a Message Authentication Code (MAC) on the Domain Move RO. Device 27 needs to be able to derive this MAC key also. The MAC key is derived from the domain key using a well established key derivation method. The Domain Move RO, including all these elements, is generated at step 112. At step 114 the Domain Move RO is embedded with the encrypted domain rights object within the content (DCF) to be consumed by the device 27. At step 116 the domain rights object is disabled for use on the giving/sending device 1. If the user of device 1 is permanently giving the rights object to device 27, then the domain rights object of device 1 will be permanently disabled. Step 116 may be performed before or after step 114. In the event of permanent giving of the content, in addition to the rights object, the key K1 will also be disabled/deleted from device 1.

The device 1 then transmits the encrypted content (DCF) to the device 27 in message 118, “DomainMove(Content)”. The receiving device 27, if not a member of the domain 24, can use the mechanisms defined within OMA DRM version 2.0 (and described above) to attempt to join the domain. If/when the device 27 is a member of the domain, the device 27 can receive the content and confirms receipt of the content to device 1 by generating a domain move response message 120 “DomainMoveResponse”.

At step 122 the device 27 verifies the MAC of the Domain Move RO. Device 27 also obtains K1 in accordance with the rules defined within the Domain Move RO and is therefore able to get access to the original domain rights object.

If the Domain Move RO is only allowed access for a defined period of time, when that period of time has expired, the receiving device 27 is no longer able to gain access to the original domain rights object. In addition, after this period of time, the original rights object may be enabled on the sending device 1.

1. A method of controlling use of content data, the method including:
receiving encrypted content data at a first device from a content provider;
receiving decryption data at the first device from a rights issuer for allowing decryption of the encrypted content data so that the content data can be consumed; and
enabling a second device to consume the content data received by the first device, the content data being consumed by the first and second devices in a controlled manner.

2. The method of claim 1, wherein the first device is a member of a domain.

3. The method of claim 2, wherein the domain is such that devices which are members of the domain can share decryption data received from the rights issuer so that the associated content can be consumed by the member devices sharing the shared decryption data.

4. The method of claim 2, wherein the first device is operable to enable the second device to become a member of the domain so that the second device can consume the content data received by the first device.

5. The method of claim 4, wherein the first device enables the second device to become a member of the domain only temporarily.

6. The method of claim 5, wherein the user of the first device determines the duration of the temporary membership of the domain.

7. The method of claim 1, wherein the first device is operable to transmit the received decryption data to the second device to enable the second device to consume the content data, and wherein the first device is prevented from consuming the content data when the second device is enabled to consume the content data.

8. The method of claim 7, wherein the second device is only enabled to consume the content data for a predetermined time period, where after the first device is able to consume the content.

9. The method of claim 8, wherein the user of the first device determines the duration of the predetermined time period.

10. The method of claim 8, wherein special decryption data is generated to enable the second device to consume the content data.

11. The method of claim 10, wherein the first device obtains permission from the rights issuer to enable the second device to consume the content.

12. The method of claim 11, wherein the step of obtaining permission comprises the first device obtaining an authentication token from the rights issuer and providing this authentication token to the second device.

13. The method of claim 12, wherein the authentication token is obtained prior to the decryption data received by the first device being transmitted to the second device.

14. The method of claim 12, wherein the authentication token enables the second device to consume the said content and other content.

15. A system for controlling use of content data, the system including:
means for sending encrypted content data to a first device from a content provider;
means for sending decryption data to the first device from a rights issuer for allowing decryption of the encrypted content data so that the content data can be consumed; and
means for enabling a second device to consume the content data received by the first device, the content data being consumed by the first and second devices in a controlled manner.

16. The system of claim 15, wherein the first device is a member of a domain.

17. The system of claim 16, wherein the domain is such that devices which are members of the domain can share decryption data received from the rights issuer (so that the associated content can be consumed by the member devices sharing the shared decryption data.

18. The system of claim 16, wherein the first device is operable to enable the second device to become a member of the domain so that the second device can consume the content data received by the first device.

19. The system of claim 18, wherein the first device is operable to enable the second device to become a member of the domain only temporarily.

20. The system of claim 18, wherein the user of the first device is operable to determine the duration of the temporary membership of the domain.

21. The system of claim 15, wherein the first device is operable to transmit the received decryption data to the second device to enable the second device to consume the content data, and wherein the first device is prevented from consuming the content data when the second device is enabled to consume the content data.

22. The system of claim 21, wherein the second device is only enabled to consume the content data for a predetermined time period, where after the first device is able to consume the content.

23. The system of claim 22, which is arranged such that the user of the first device determines the duration of the predetermined time period.

24. The system of claim 22, wherein special decryption data is generated to enable the second device to consume the content data.

25. The system of claim 15, wherein the first device obtains permission from the rights issuer to enable the second device to consume the content.

26. The system of claim 25, including means for providing the first device with an authentication token from the rights issuer and providing this authentication token to the second device.

27. The system of claim 26, wherein the authentication token is provided prior to the decryption data received by the first device being transmitted to the second device.

28. The system of claim 26, wherein the authentication token enables the second device to consume the said content and other content.

29. The system of claim 15, wherein the content provider is remote from the first device.

30. The system of claim 15, wherein the rights issuer is remote from the first device.

31. The system of claim 15, wherein the first device comprises a mobile telecommunications device.

32. The system of claim 15, wherein the second device comprises a mobile telecommunications device.

33. The method of system of claim 31 of 32, wherein the or each mobile telecommunications device communicates wirelessly with a mobile telecommunications network.

34. The system of claim 33, wherein the encrypted content data received at the first device is transmitted via the mobile telecommunications network.

35. The system of claim 33, wherein the decryption data received at the first device is transmitted via the mobile telecommunications network.

36. The system of claim 33, wherein the mobile telecommunications network comprises a GSM mobile telecommunications network.

37. The system of claim 33, wherein the mobile telecommunications network comprises a UMTS mobile telecommunications network.

38. The system of claim 16, wherein each of the devices in the domain share a domain key.

39. The system of claim 15, wherein the domain comprises a domain as defined in the Open Mobile Alliance DRM Specification version 2.0 or any subsequent version thereof.

40. The system of claim 15, wherein the decryption data controls or restricts use of the content data.

41. The system of claim 15, wherein the decryption data specifies the number of times that the content data can be used.

42. The system of claim 33, wherein the mobile telecommunications device is authenticated with a mobile telecommunications network.
